(19) United States
(12) Patent Application Publication
(10) Pub. No.: US 2008/0266310 A1
(43) Pub. Date: Oct. 30, 2008

(54) System and method for multiple color format spatial scaling

(76) Inventors: Kayla Chalmers, Austin, TX (US); Bradley C. Aldrich, Austin, TX (US)

Correspondence Address: BUCKLEY, MASCHOFF & TALWALKAR LLC, 50 LOCUST AVENUE, NEW CANAAN, CT, 06840, US

(21) Appl. No.: 11/394,852

(22) Filed: Mar. 31, 2006

(51) Int. Cl. G09G 5/00

(52) U.S. Cl. 345/589; 345/667

(57) ABSTRACT

A method, apparatus, and system to scale a color image, the method including determining a color format of image data representative of the color image, the image data being in a pre-processed format and an unprocessed format; and performing a two-dimensional (2-D) image scaling operation on the image data, wherein a plurality of separable one-dimensional filters are applied to the image data to provide a scaled image of the color image and the image scaling operation is the same for the pre-processed formatted image data and the unprocessed formatted image data.

### BACKGROUND

There is an increasing convergence of multimedia devices such that some devices include functionality to process a variety of media types in a number of formats. For example, a personal digital assistant (PDA), a video camera, a mobile phone, and a portable email device may each include a camera or image capture device therein. Due in part to the variety of devices and applications served by those devices, the data processed by the devices may vary even though there may be some overlap in functionality within and between the devices. For example, a mobile phone and a video camera may both capture images but the mobile phone may not have the processing and storage capabilities of the video camera.

To address the differing image processing tasks of current and future image processing devices, a method and system to process multiple color formats would be beneficial.

### BRIEF DESCRIPTION OF THE DRAWINGS

FIG. 1 is an exemplary illustration of an apparatus, in accordance with some embodiments herein;

FIG. 2 is an exemplary illustration of a filter kernel, in accordance with some embodiments herein;

FIG. 3 is an exemplary illustration of a filter kernel, in accordance with some embodiments herein;

FIG. 4 is an exemplary depiction of a scaling operation, in accordance with some embodiments herein;

FIG. 5 is an exemplary illustration of a scaling operation, in accordance with some embodiments herein;

FIG. 6 is an exemplary illustration of a scaling operation, in accordance with some embodiments herein; and

FIG. 7 is a schematic of an exemplary device, according to some embodiments hereof.

### DETAILED DESCRIPTION

The several embodiments described herein are solely for the purpose of illustration. Embodiments may include any currently or hereafter-known versions of the elements described herein. Therefore, persons in the art will recognize from this description that other embodiments may be practiced with various modifications and alterations.

Regarding, for example, handheld and embedded systems, there is an interest in including video and image encoding functionality into such systems. Example systems may include a mobile wireless phone, Voice Over IP (VoiP) telephones, PDAs, and digital cameras. In some embodiments, a CMOS (complementary metal oxide semiconductor) image sensor may be incorporated into the system.

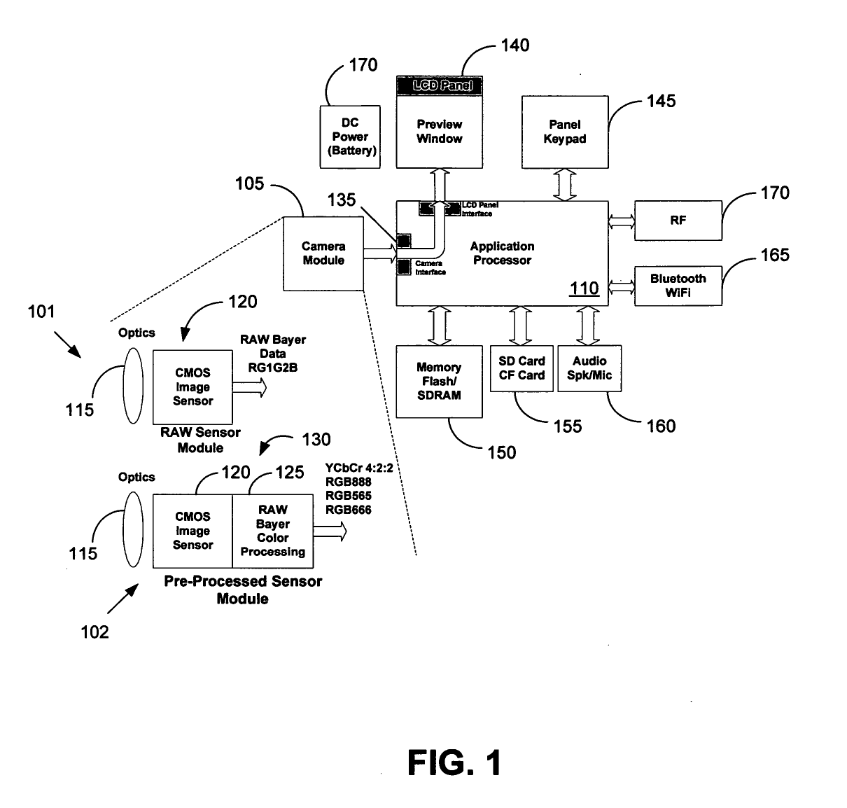

A number of image capture solutions may be provided for a device or system. FIG. 1 shows an exemplary system including image capture functionality. In some embodiments, a device may include more than one type of image sensor, the use of which may vary depending on the particular function invoked by the device. Thus, the data processing performed by the device (e.g., a mobile phone, a video camera, etc.) may vary depending on the application.

In some embodiments, the image capture functionality of system 100 may be implemented by a camera module 105 and an Application Processor (AP) 110. In some embodiments, camera module 105 may include both an unprocessed RAW sensor module 101 and a pre-processed sensor module 102 that each operate to provide image capture functionality. RAW sensor module 101 may include an optics component 115 and a CMOS image sensor 120. Pre-processed sensor module 102 may include an optics component 115, a CMOS image sensor 120, and an image signal processor (ISP) 125. RAW sensor module 101 operates to provide unprocessed or RAW image data to a camera interface 135. Pre-processed sensor module 102 operates to provide pre-processed image data to camera interface 135. CMOS sensor 120 and ISP 125 comprise an integrated CMOS sensor 130. Accordingly, system 100 may provide RAW image data and pre-processed image data to AP 110.

It should be appreciated that a number of the components of system 100 are provided for illustrative purposes of an exemplary operating environment or implementation. As such, details of power supply 105, keypad 145, and wireless communication modules 165 and 170 are not discussed in detail herein.

In some embodiments, the inclusion of both RAW sensor module 101 (non-integrated CMOS sensor) and pre-processed sensor module 102 (integrated CMOS sensor) in a device or system presents a need for AP 110 to process both RAW image data and processed image data. Further, there may be applications that use RAW image data and applications that use processed image data. For example, an onboard preview window 140 may use pre-processed image data to provide a display of a captured image prior to and/or during the storage thereof to a memory storage device such as, for example, memory 150, 155, and 160. RAW image data may be further processed by AP 110 regarding a number of characteristics.

A number of image processing operations may be performed on image data. The image process techniques may be implemented using a processing algorithm. Examples of processing algorithms include dead pixel correction, image scaling, color synthesis, color space conversion, color correction, white balancing, etc. Image scaling is a mechanism to reduce (or enlarge) a captured image by a ratio. Image scaling to reduce the size of an image may collapse a number of pixels of an input image into one pixel of an output, scaled down image. To effectuate image scaling, a spatial image processing algorithm and filters may be used. The particular image scaling algorithm used may impact a perceived quality of an imaged scaled using the particular algorithm.

In some embodiments, an image may be scaled in two directions, a horizontal direction and a vertical direction. That is, a two-dimensional (2-D) image scaling processing operation may be used. In some embodiments, two separate one-dimensional image scaling processes may be used, each in different directions to achieve the desired 2-D image scaling processing. In particular, a finite impulse response (FIR) filter may be used to implement the one dimensional image scaling processes.

In some embodiments, image data may be convolved with a two-dimensional 2-D image scaling processing operation. The FIR may perform a smoothing or dampening function. In some embodiments, two separate one-dimensional image scaling processes may be used, each in different directions to achieve the desired 2-D image scaling processing. In some embodiments, two separate one-dimensional scaling processes may be used to achieve the 2-D image scaling. In particular, separable FIRs may be used. Using separable FIRs may reduce the amount of calculations needed to determine the scaled output image.

To convolve an image, a 2-D filter kernel of finite dimensions is aligned with an equal sized subset of the image and then scanned across the image in multiple steps. At each step in the convolution a different group of pixels are aligned with the kernel. Each of the corresponding overlapping elements is multiplied with the elements of the kernel. The resulting products of the element multiplications are accumulated, scaled as necessary, and then stored to an output image array. The convolution operation can be expressed as the finite sum in the following equation:

$$c ( m , n ) = {\sum }_{j = 0}^{N - 1} {\sum }_{k = 0}^{M - 1} a ( j , k ) \cdot h ( m - j , n - k ) \qquad ( 1 )$$

where c(m,n) represents the output image, a(j,k) represents the input image, and h(m-j,n-k) represents the convolution kernel.

Several issues may occur with applying a convolution kernel to images. For example, regarding equation (1) it is noted that centering the kernel around the edges of the image requires values of a(j,k) that are outside of the boundaries. There are several approaches to handling the nonexistent values of the image for j<0, j>=M, k<0, and k>=N. In some embodiments, the image may be extended using extra rows and columns around the border thereof. The extra elements can be zero, mirrored values, or a constant.

The size of the convolution kernel can be set to any size. For practical implementations, the size of the kernel may be a 3×3 or 5×5 matrix. Convolution may be done with separate input and output images so the outputs of each convolution step does not affect neighboring calculations. Low-pass and high-pass filters are may be used as a basis for most spatial filtering operations.

The total number of operations required to perform 2-D convolution is high. For example, for an image that is N×N in size and a kernel that is K×K in size, the total number of multiply and add operations is N²K². In some instances it is possible to develop a more efficient implementation if the filter can be decomposed into separable row and column filters.

$$c ( m , n ) = {\sum }_{j = 0}^{N - 1} \{ {\sum }_{k = 0}^{M - 1} a ( m - j , n - k ) \cdot {h}_{row} ( k ) \} {h}_{column } ( k ) \qquad ( 2 )$$

Thus, it is possible to apply two one-dimensional filters to scale an image, one along the rows and one along the columns. The total number of operations required to process the rows and columns is reduced to a total of N²K. The separable filters may be used to achieve fast implementations and can provide very good throughput and performance.

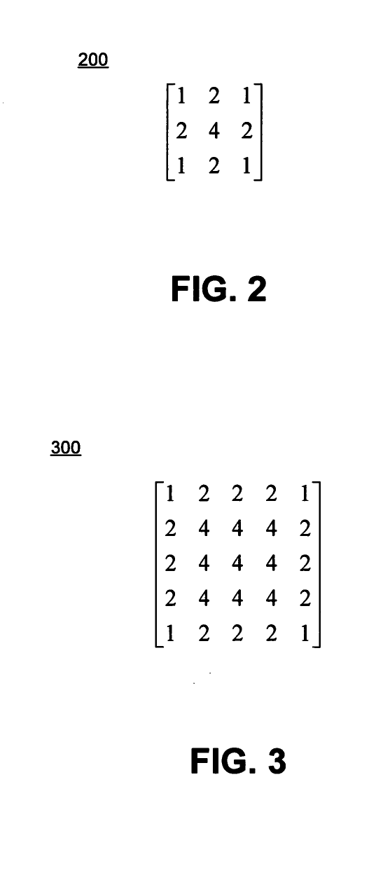

A three or five tap value FIR filter may be used for each scaling pass. In some embodiments, the tap coefficients are (1,2,1) or (1,2,2,2,1), which are the same for both dimensions. A 3×3 filter kernel 200 is illustrated in FIG. 2. A 5×5 filter kernel 300 is illustrated in FIG. 3. The normalization factor for the FIR filters are 4 and 8, respectively, for each pass. As such, a 3×3 or 5×5 overlapping pixel window may be reduced or scaled down to one pixel.

In accordance with some embodiments herein, a scaling process is provided for operating on either unprocessed image data such as RAW RGGB or processed image data such as YUV422, RGB888, RGB666, and RGB565. The processed and unprocessed image data may be received from RAW image data sensor module 101, pre-processed image sensor module 102, a CCD image sensor, and other image processing hardware (not shown).

It should be appreciated that image data in formats other than those specifically listed herein may be operated on or processed in accordance with the present disclosure. That is, both unprocessed and pre-processed image data may be scaled in accordance herewith.

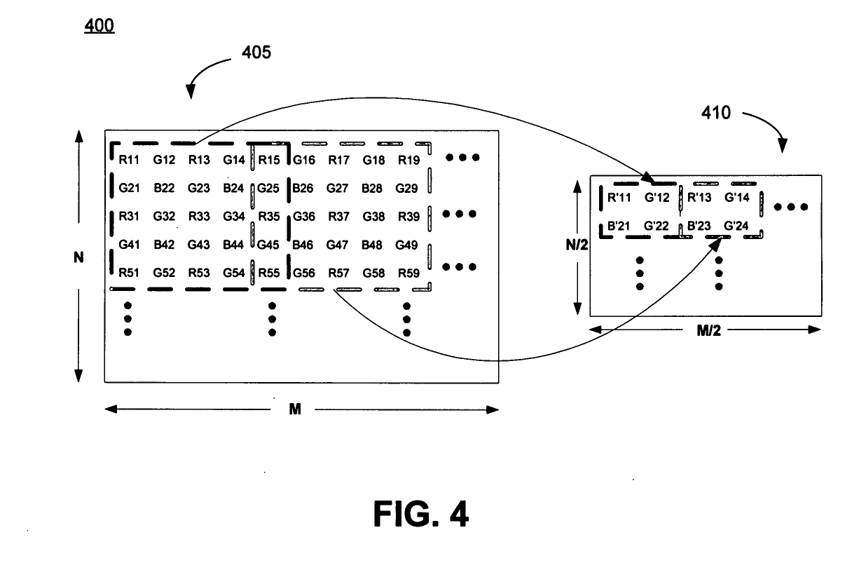

FIG. 4 illustrates a 2:1 scaling operation 400 for the scaling of RAW RGGB Bayer pattern data. Input image 405 is reduced to output image 410. Each 5×5 sample of input image 405 is reduced to a single pixel in output image 410. It is noted that the Bayer color space characteristics of the image data is maintained between input image 405 and output image 410.

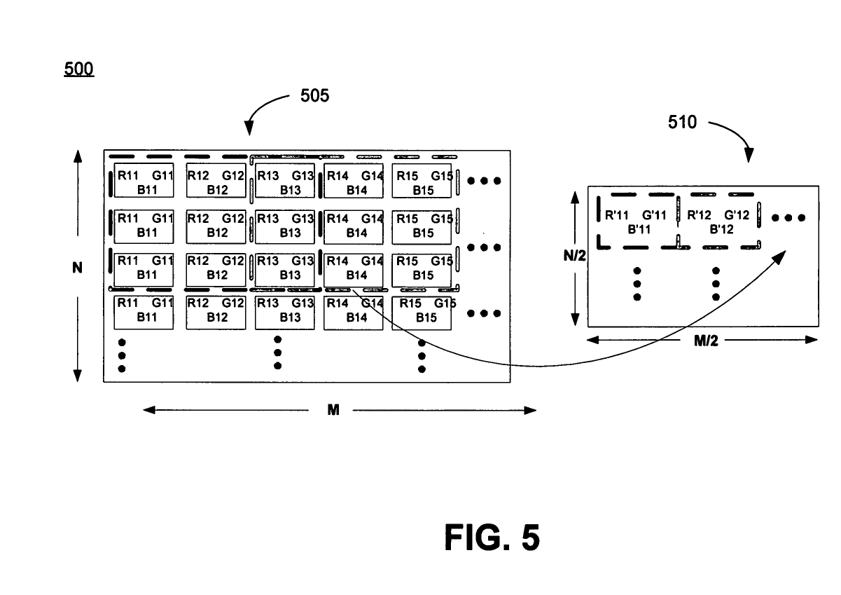

FIG. 5 illustrates a 2:1 scaling operation 500 for the scaling of pre-processed RGB pattern data. Image 505 is reduced to output image 510. The M×N input image 505 is reduced to M/2×N/2 output image 510. Each 3×3 sample of input image 505 is reduced to a single pixel of output image 510. The color space characteristics of the image data is maintained between input image 505 and output image 510.

FIG. 6 illustrates a 2:1 scaling operation 600 for the scaling of pre-processed YUV422 pattern data. Image data 605 is reduced to output image 610. The M×N input image 605 is reduced to M/2×N/2 output image 610. Each 3×3 sample of input image 605 is reduced to a single pixel of output image 610.

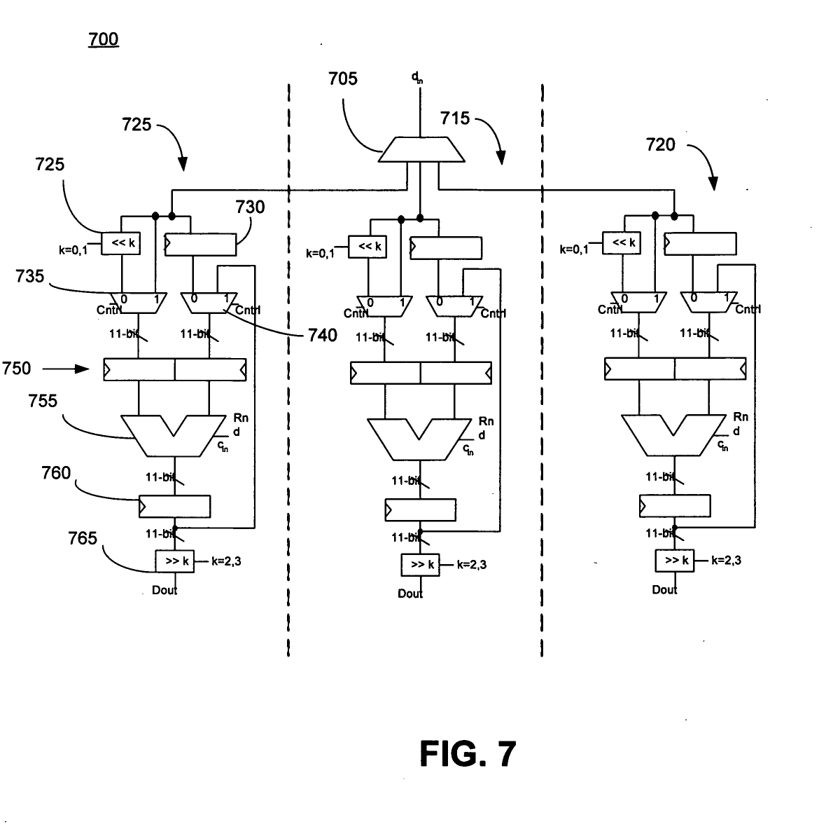

In some embodiments, depending on the color format of the image data and precision desired for the output image, pixel components of an input image may be decoded into three pipes or channels as illustrated in FIG. 7. Scaling device 700 includes three channels, channels 710, 715, and 720. Each channel performs a filtering operation on a different component of the input image received at demultiplexer 705. For example, an input of RGB565 image data may be separated into three filters corresponding to a red channel of 5-bit pixels (710), a green channel of 6-bit pixels (715), and a blue channel of 5-bit pixels (720). It is noted that for channel 710 the input signal comprises the Red components for din(1), din(2), din(3), din(4), . . . ; the input signal for channel 715 comprises the Green components of din(1), din(2), din(3), din(4), . . . ; and the input signal for channel 720 comprises the Blue components for din(1), din(2), din(3), din(4), . . . .

Each channel of scaling device 700 performs scale and accumulate operations on the input image data received in each respective channel. The illustrative registers (730, 750, 760), multiplexers (735, 740), adders (755), and scale units (725, 765) are used to perform the scale and accumulate operation for each filter channel, based on a filter kernel (e.g., 200, 300) and the coefficients therein. For each channel the results of a first dimension (e.g., horizontal rows) are stored for processing in the second dimension (e.g., vertical columns). With the exception of the first row, the vertical filtering is performed using the same processing operations as the horizontal filtering. To obtain the scaled down output image, three vertical filter results are assembled back to original color format and precision (e.g., RGB565) before outputting the final scaled result.

Referring to FIG. 7 for a 2:1 scaling operation, the control selects on multiplexers 735 and 740 are the same value. For example, the first sum is selected by both multiplexer controls being ‘0’. For a second sum, the controls would switch to ‘1’. It is noted that the input to the multiplexers can be swapped, for which the control values would be reversed.

In some embodiments, the three channels 710, 715, and 720 may be at different steps in a filtering operation. That is, one or more of channels 710, 715, 720 may be processing an input image signal synchronously or asynchronously. A data rate of the image sensor (e.g., 101, 102) may be a factor in determining whether channels 710, 715, 720 operate synchronously or asynchronously.

For a 2:1 scaling mode of operation and an input sequence of din(1), din(2), din(3), din(4) . . . , the outputs for even and output summations are shown below.

| Even Outputs | Odd Outputs |
|---|---|
| Sum = din(1) + din(2)<<1 | |
| Sum = sum + din(3) | |
| dout = sum >> 2 | Sum1 = din(3) + din(4) <<1 |
| | Sum1 = sum1 + din(5) |
| | dout = sum >> 2 |

For a 4:1 scaling mode of operation the multiplexer controls may not be the same value. For example, the first sum is selected by both multiplexer controls being ‘0’. For the second and third sums, the multiplexer controls would not be the same value. The left multiplexer 725 control would remain a ‘0’ and the right multiplexer 730 would switch to ‘1’. The fourth sum would result from both multiplexer control values being set to ‘1’. The input to the multiplexers can be swapped, such that the control values are reversed.

For a 4:1 scaling mode of operation and an input sequence of din(1), din(2), din(3), din(4), . . . , the outputs for even and output summations are shown below.

| Even Outputs | Odd Outputs |
|---|---|
| Sum = din(1) + din(2)<<1 | |
| Sum = sum + din(3)<<1 | |
| Sum = sum + din(4)<<1 | |
| Sum = sum + din(5) | |
| dout = sum >> 3 | Sum1 = din(5) + din(6)<<1 |
| | Sum1 = sum1 + din(7)<<1 |
| | Sum1 = sum1 + din(8)<<1 |
| | Sum1 = sum1 + din(9) |
| | dout = sum1 >> 2 |

In accordance with some embodiments herein, as demonstrated by, for example, some of the system and scaling device embodiments, a scaling operation may be performed on image data of various formats, including processed and unprocessed image data. In accordance herewith, a hardware and software implemented scaling operation for both processed and unprocessed color image data may be provided without a need to tune or modify the scaling operation to the particular image data being processed. For example, there may not be a need or desire to have a system processor intervene to process a video preview stream for scaling to match the display on the LCD viewfinder (140). In this manner, flexibility of operation may be provided.

Some embodiments herein may be implemented in hardware, software, firmware, and combinations thereof. Some aspects of the processes disclosed herein may be stored as code, instructions, applications, applets, directions, links, and pointers on a computer readable medium such as, for example, a flash memory, a CD-ROM, a smart card, etc. In some embodiments, code, instructions, applications, applets, directions, links, and pointers for implementing aspects herein may be received by a device or system from a remote data source of provider such as, for example, an internet service provider, a wireless service provider, etc.

It should be appreciated that the drawings herein are illustrative of various aspects of the embodiments herein, not exhaustive of the present disclosure. The several embodiments described herein are solely for the purpose of illustration. Persons in the art will recognize from this description that other embodiments may be practiced with modifications and alterations limited only by the claims.

What is claimed is:

1. A method to scale a color image, the method comprising:
determining a color format of image data representative of the color image, the image data being in a pre-processed format and an unprocessed format; and
performing a two-dimensional (2-D) image scaling operation on the image data, wherein a plurality of separable one-dimensional filters are applied to the image data to provide a scaled image of the color image and the image scaling operation is the same for the pre-processed formatted image data and the unprocessed formatted image data.

2. The method of claim 1, wherein the performing of the scaling operation includes convolving the plurality of filters with the image data.

3. The method of claim 1, wherein each of the plurality of filters operates on a single component of the image data.

4. The method of claim 2, wherein the plurality of filters are each a finite impulse response (FIR) filter.

5. The method of claim 4, wherein the FIR is a one of a 3-tap filter and a 5-tap filter.

6. The method of claim 1, wherein each of the plurality of filters operates on image data input thereto in a first dimension and then in a second dimension.

7. The method of claim 1, wherein the scaled image is provided in a format that is the same as the determined color format.

8. An apparatus comprising:
a first image sensor module to provide unprocessed image data;
a second image sensor module to provide pre-processed image data;
a camera interface to receive image data from both the first and the second image sensor modules; and
a processor to perform a two-dimensional (2-D) image scaling operation on the image data captured by both the first and the second image sensor modules.

9. The apparatus of claim 8, wherein the performing of the scaling operation on the image data uses a plurality of separable one-dimensional filters applied to the image data to provide a scaled image of the color image and the image scaling operation is the same for the pre-processed formatted image data and the unprocessed formatted image data.

10. The apparatus of claim 9, wherein the performing of the scaling operation includes convolving the plurality of filters with the image data.

11. The apparatus of claim 9, wherein each of the plurality of filters operates on a single component of the image data.

12. The apparatus of claim 11, wherein the plurality of filters are each a finite impulse response (FIR) filter.

13. The apparatus of claim 12, wherein the FIR is a one of a 3-tap filter and a 5-tap filter.

14. The apparatus of claim 9, wherein each of the plurality of filters operates on image data input thereto in a first dimension and then in a second dimension.

15. The apparatus of claim 8, wherein the processor further determines a color format of image data representative of the color image, the image data being in a pre-processed format and an unprocessed format.

16. The apparatus of claim 15, wherein the scaled image is provided in a format that is the same as the determined color format.

17. The apparatus of claim 8, further comprising a display panel to display a preview of a scaled image prior to processing by the processor.

18. A system comprising:
a first image sensor module to provide unprocessed image data;
a second image sensor module to provide pre-processed image data;
a camera interface to receive image data from both the first and the second image sensor modules;
a processor to perform a two-dimensional (2-D) image scaling operation on the image data captured by both the first and the second image sensor modules; and
a radio frequency module to communicate via a radio frequency.

19. The system of claim 18, wherein the performing of the scaling operation on the image data uses a plurality of separable one-dimensional filters applied to the image data to provide a scaled image of the color image and the image scaling operation is the same for the pre-processed formatted image data and the unprocessed formatted image data.

20. The system of claim 18, wherein the performing of the scaling operation includes convolving the plurality of filters with the image data.

21. The system of claim 18, wherein the processor further determines a color format of image data representative of the color image, the image data being in a pre-processed format and an unprocessed format.
